(19) United States
(12) Patent Application Publication
(10) Pub. No.: US 2025/0278679 A1
(43) Pub. Date: Sep. 4, 2025

(54) TECHNOLOGIES FOR SCENARIO FORECASTING ELECTRIFICATION OF VEHICLE FLEET

(71) Applicant: SARGENT & LUNDY, L.L.C., Chicago, IL (US)

(72) Inventor: Kalpesh CHAUDHARI, Chicago, IL (US)

(21) Appl. No.: 19/053,310

(22) Filed: Feb. 13, 2025

Related U.S. Application Data
(60) Provisional application No. 63/560,422, filed on Mar. 1, 2024.

(51) Int. Cl. G06Q 10/04; G06Q 10/0635

(52) U.S. Cl. CPC G06Q 10/04; G06Q 10/0635

(57) ABSTRACT

A system and method for performing forecasts for entities planning to transition from a vehicle fleet with internal combustion engines (“ICE”) to an electric vehicle (“EV”) fleet is provided. The total cost of ownership is determined regarding the replacement fleet of EVs based on vehicle energy analytics regarding the existing fleet of ICE vehicles and the replacement fleet of EVs. Financial analytics regarding potential grants, credits and/or incentives for the replacement fleet of EVs could be factored into the determination. There is a user interface that displays a forecast regarding the total cost of ownership. In some cases, the user interface includes user-adjustable elements to change one or more parameters regarding the vehicle energy analytics and the financial analytics, such that adjustments to total cost of ownership are made in real-time based on adjustment to the user-adjustable elements.

### RELATED APPLICATIONS

This application claims the benefit of U.S. Provisional Application No. 63/560,422 filed Mar. 1, 2024 for “Technologies for Scenario Forecasting Electrification of Vehicle Fleet,” which is hereby incorporated by reference in its entirety.

### TECHNICAL FIELD

This system relates generally to a computerized system of performing projections and forecasts for entities planning to transition from a vehicle fleet with internal combustion engines (“ICE”) to an electric vehicle (“EV”) fleet; in particular, this system relates to a forecasting system that can predict, among other things, the total cost of ownership when making the transition to a vehicle fleet with EVs based on a variety of user-adjustable scenarios.

### BACKGROUND

There is a trend underway to transition from vehicles with internal combustion engines (“ICE”) to electric vehicles (“EVs”). For entities with vehicle fleets, EVs can reduce the total cost of ownership due to lower fuel costs, government incentives, tax benefits, lower maintenance costs, and potential vehicle-to-grid (“V2G”) revenue from selling energy back to the utilities. However, vehicle fleet electrification can be a large capital expenditure, and determining the timing and financial impact of replacing a vehicle fleet with EVs is be extremely complex. For example, the financial impact can depend on the site location where the EVs are deployed because utility electricity rates can differ, and depends on fuel costs, electricity cost and the V2G revenue, among other things.

Due to these complexities, there is a need for a system that allows vehicle fleet owners and/or operators to determine the financial impact of electrifying the fleet, and the forecast the timing of that financial impact.

### BRIEF DESCRIPTION OF THE DRAWINGS

The present disclosure will be described hereafter with reference to the attached drawings which are given as non-limiting examples only, in which:

FIG. 1 is simplified block diagram of a system for forecasting a variety of scenarios during a transition from an ICE vehicle fleet to a EV vehicle fleet according to an embodiment of the present disclosure;

FIG. 2 is a simplified block diagram of at least one embodiment of a computing device for the system of FIG. 1 according to an embodiment of this disclosure;

FIGS. 3A-3H are simplified tables illustrating various input data, process types and decision points that may be used in a method that may be executed by the system of FIG. 1 according to an embodiment of the present disclosure; and

FIGS. 4-9 illustrate example user interfaces that may be provided by the system of FIG. 1 according to an embodiment of this present disclosure.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The system provides a technical solution to several technical problems. In some embodiments, this disclosure relates to a system that can be used to provide insights to an organization wanting to transition from a vehicle fleet with internal combustion engines (“ICE”) to a fleet with electric vehicles (“EVs”). For example, the system could predict, among other things, total cost of ownership for an entity, provide a feasibility analysis of the transition, and a grid integration analysis. In some embodiments, there are a variety of scenarios that are user-adjustable to determine impact of the various scenarios on the transition to EVs. In this manner, the system may enable efficient and optimal fleet electrification and charging infrastructure deployment. For example, the system could optimally locate and configure (e.g., quantity and capacity) of charging infrastructure across multiple sites for a fleet electrification plan. In some embodiments, the system could provide insights for negotiation with utilities on electricity pricing (both for consumption and also as part of V2G/demand response application). In some cases, the system is configured to provide utility infrastructure planning for EV penetration, and charger quantity estimation for special-use electric vehicles, such as utility vehicles.

In some embodiments, the system may be configured to use route information from a feasibility study as an input. The technical issue with understanding real-world driving dynamics for fleet EV is also addressed in some embodiments. For example, the system can be used to determine capacity loss, seasonal variations, and/or the impact of average speed of driver (converted into energy consumption). In some embodiments, the system is configured to derive vehicle-to-grid revenue estimation from existing energy storage and solar tariff structures. In some cases, the system is configured to incorporate battery degradation into energy consumption predictions, which can affect costs.

Another technical problem addressed by the system, in some embodiments, is determining a long term strategy and roadmap for an for electrification project, such as for an entire vehicle fleet. For example, the system may be configured to address many issues surrounding fleet electrification, such as vehicle transition, charging infrastructure needs, available incentives, utility constraints, and incorporation of costs and revenue, including from other sources such as V2G, demand response, etc.

In some cases, the system is configured to address EV projection techniques for residential, workplace, and commercial charging use cases. For example, using reference databases such as the National Household Travel Survey, Department of Transportation Annual Statistics, seasonal factors, proximity to distribution feeders and distribution feeder capacity to estimate EV use growth in certain areas. In some embodiments, the system can provide optimal location identification and placement of EV infrastructure, rather than just how much can be placed at a certain location.

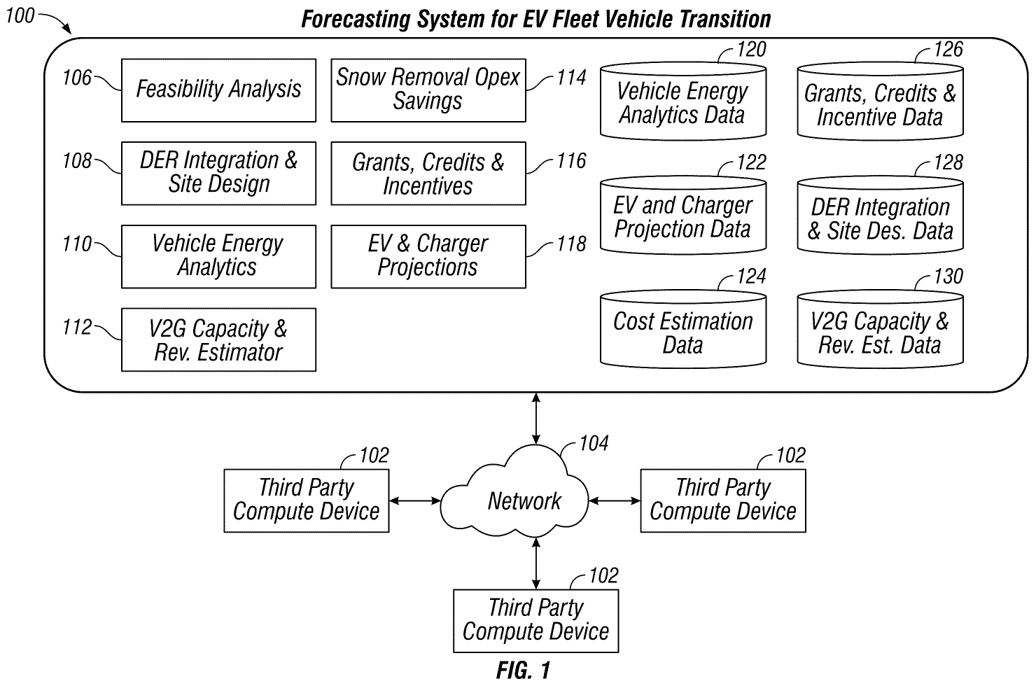

FIG. 1 illustrates an embodiment of a system 100 for performing projections and forecasts regarding the transition of a vehicle fleet from ICE vehicles to EVs. Although the system 100 is illustrated by a single block for purposes of simplicity, the system 100 could be executed on a plurality of compute devices in a cloud-based environment. For example, depending on the circumstances, the system 100 may be a software as a service (“SaaS”) platform that is accessible over a network 104, such as the Internet. In some cases, system 100 could be locally installed on a user's compute device, or could be a hybrid in which a portion of the system is installed locally on the user's compute device and a portion of the system is cloud-based.

As shown, a plurality of third party compute devices 102 are able to access the system 100 over the network 104. For example, the third party compute devices 102 could be operated by entities that are seeking forecasts for making a transition of their vehicle fleet to EVs. The third party compute devices 102 may operate software, such as a browser, to both send and receive messages with the system 100 over the network 104. Though a relatively small set of third party compute devices 102 are shown in FIG. 1 for simplicity and clarity, it should be understood that the number of compute devices 102 that access the system 100, in practice, may range in the tens, hundreds, thousands, or more.

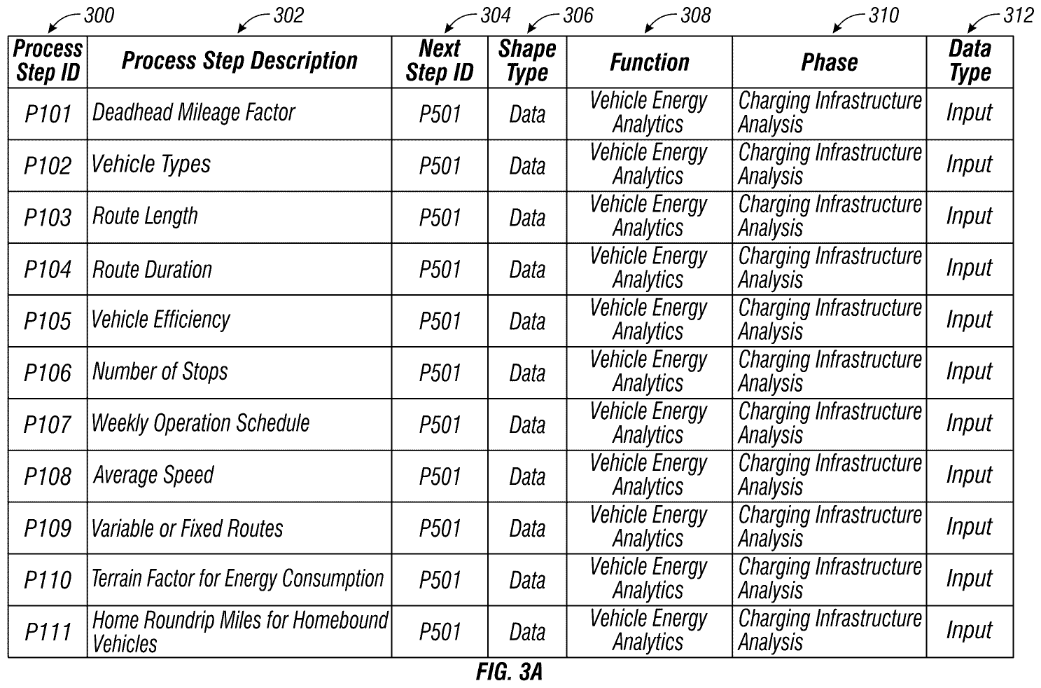

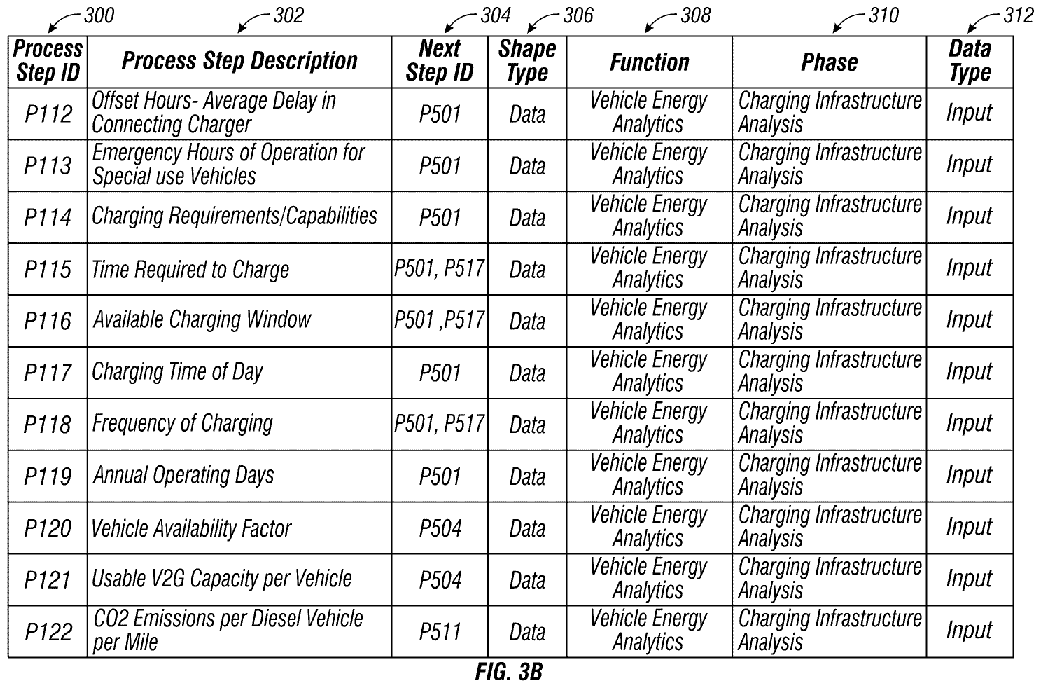

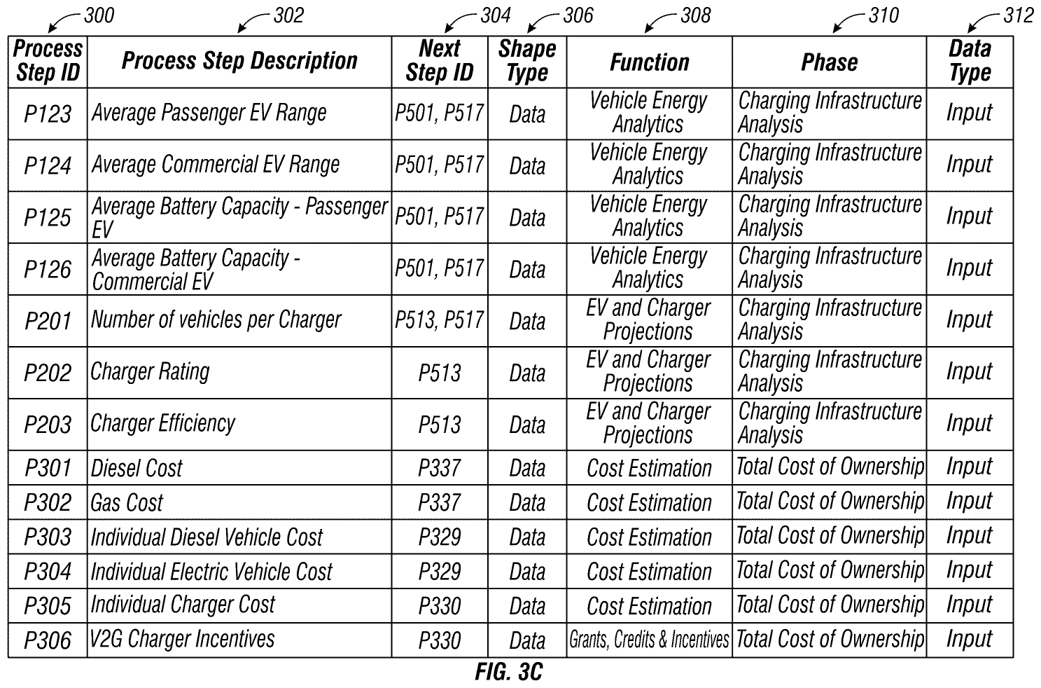

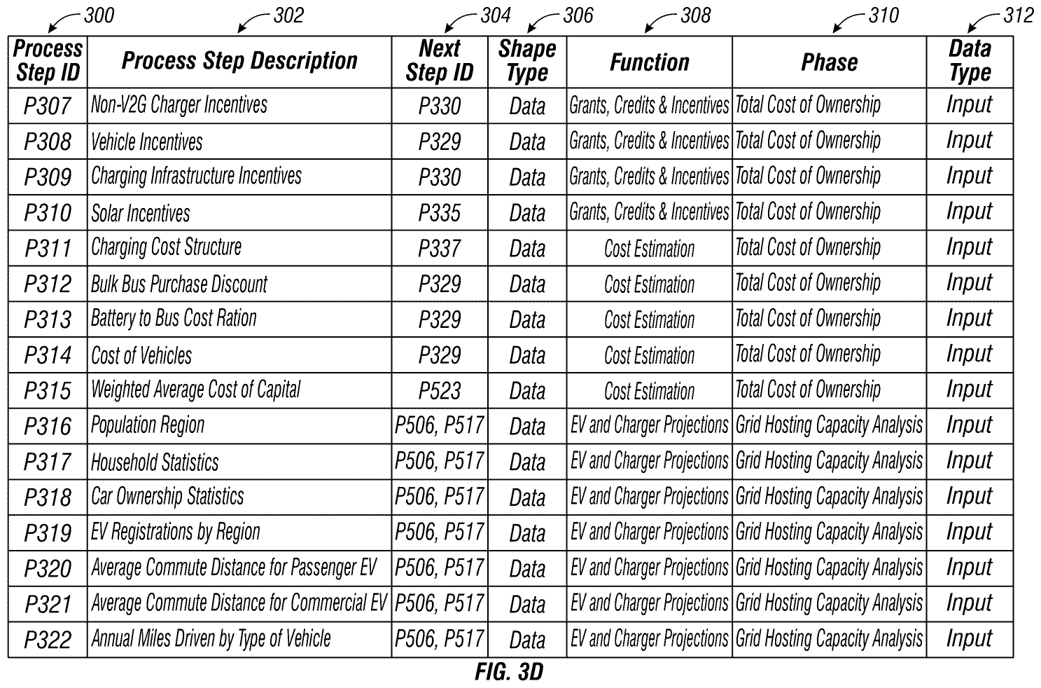

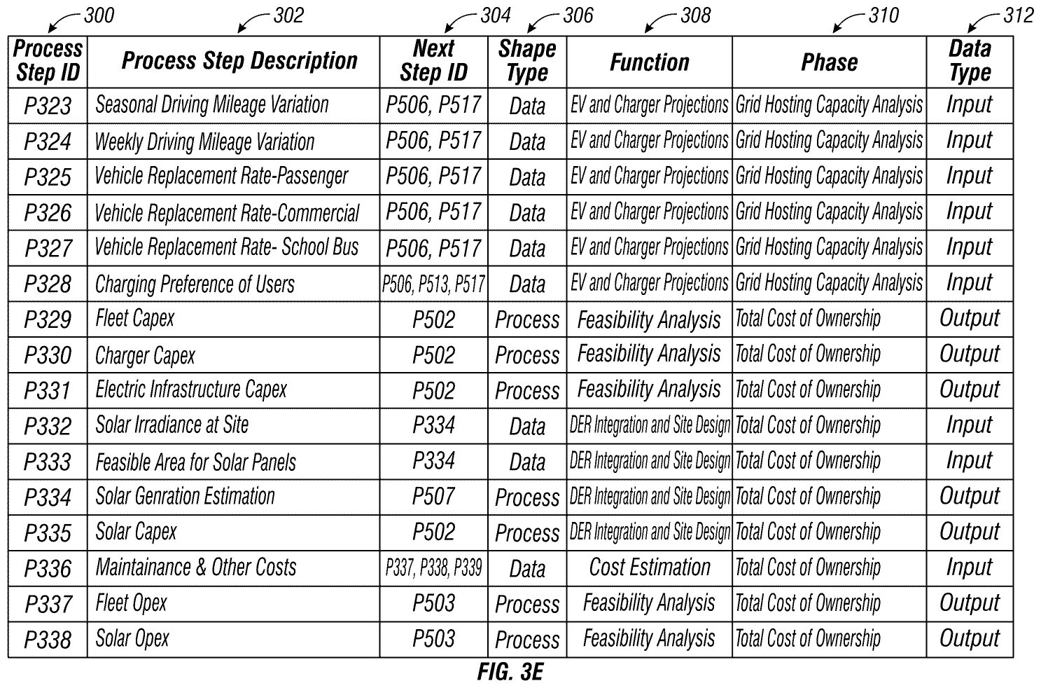

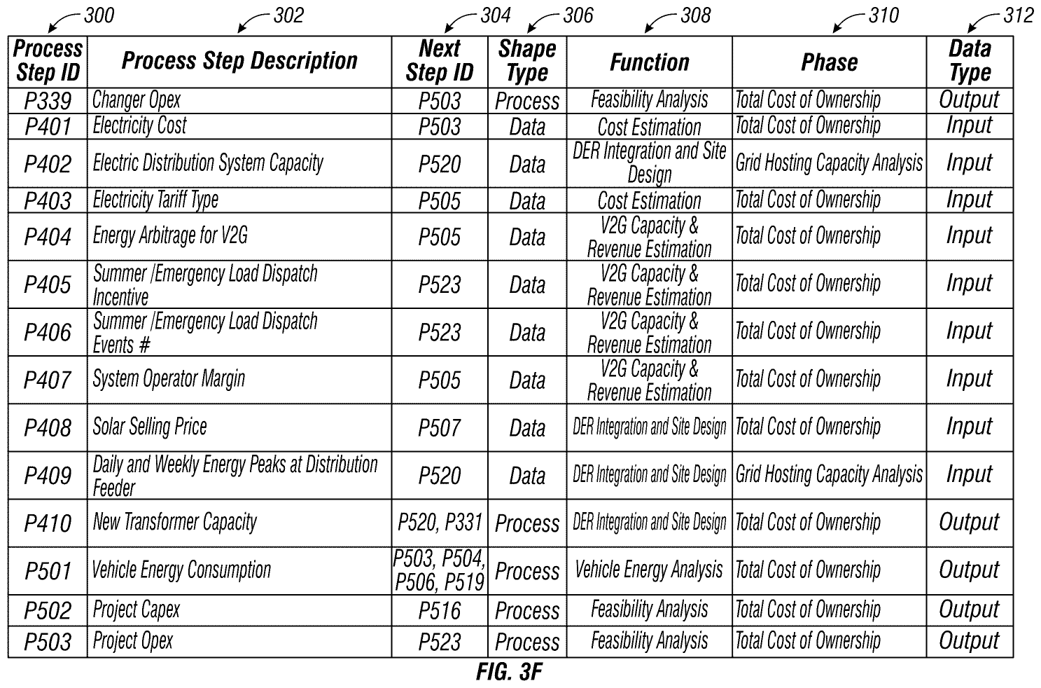

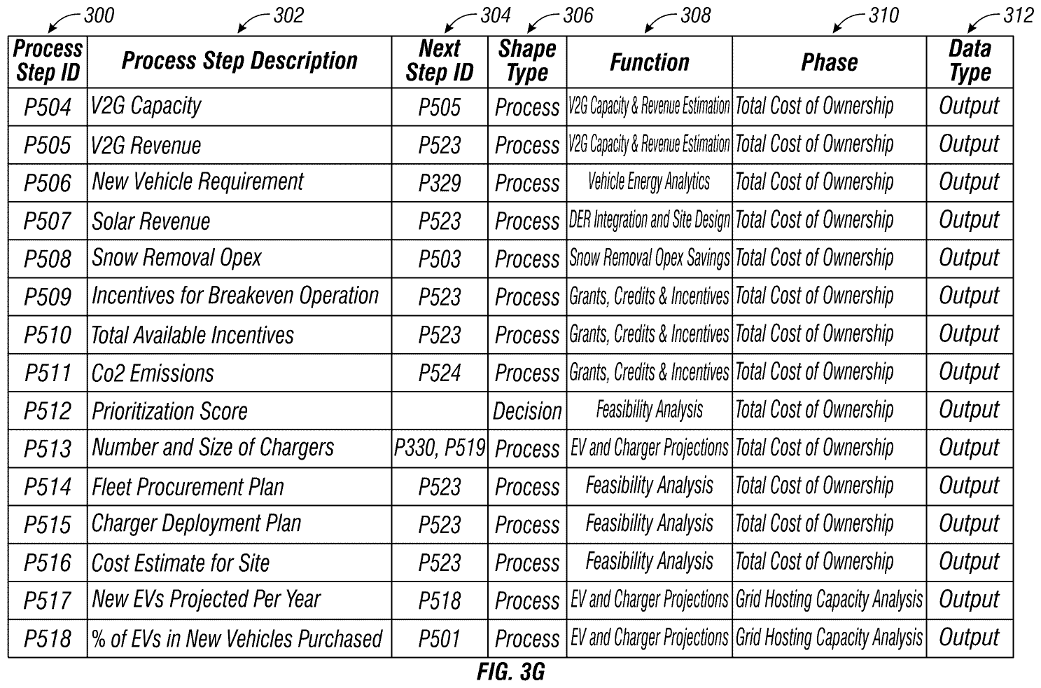

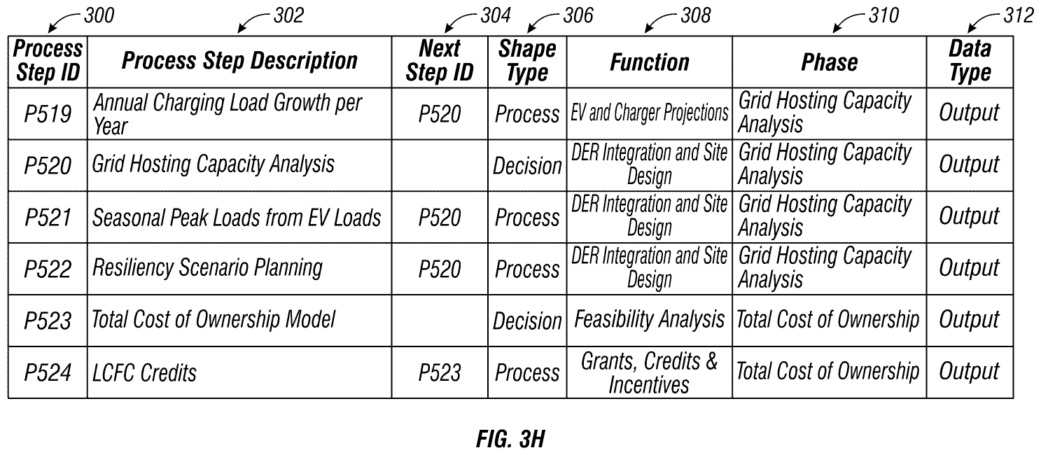

As explained herein, the system 100 may create a computing environment during operation. In the computing environment shown, the system 100 includes a feasibility analysis subsystem 106, a distributed energy resources (“DER”) integration and site design subsystem 108, a vehicle energy analytics subsystem 110, a vehicle to grid (“V2G”) capability and revenue estimator 112, a snow removal operating expense (“Opex”) savings subsystem 114, a grants, credits and incentives subsystem 116, and an EV & charger projections subsystem 118. Examples of the function for each of these subsystems regarding input data, output data, and the general process flow for each is described with respect to FIGS. 3A-3H. In the embodiment shown, the system 100 includes several data sources, such as vehicle energy analytics data 120, EV and charger projection data 122, cost estimation data 124, grants, credits and incentives data 126, DER integration & site design data 128, and V2G capability and revenue estimate data 130. Examples of these types of data is illustrated in FIGS. 3A-3H.

As shown, the various components of the system 100 may be embodied as hardware, firmware, software, or a combination thereof. As such, in some embodiments, one or more of the components of the system 100 may be embodied as circuitry or collection of electrical devices (e.g., feasibility analysis circuitry, DER integration and site design circuitry, vehicle energy analytics circuitry, V2G capability and revenue estimator circuitry, snow removal Opex savings circuitry, grants, credits and incentives circuitry, and EV & charger projections circuitry). Additionally or alternatively, in some embodiments, those components may be embodied as hardware, firmware, or other resources of the third party computing devices 102. Additionally, in some embodiments, one or more of the illustrative components may form a portion of another component and/or one or more of the illustrative components may be independent of one another.

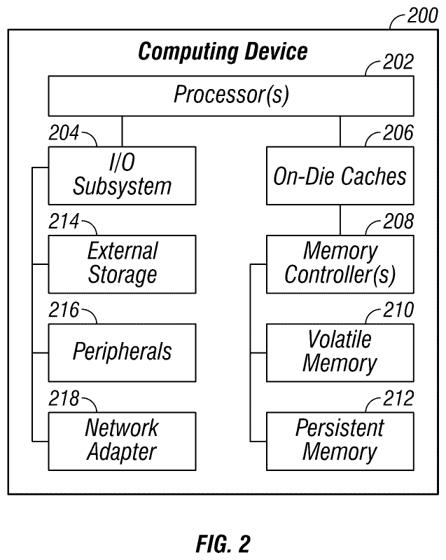

Referring now to FIG. 2, an illustrative computing device 200 for performing projections and forecasts regarding the transition of a vehicle fleet from ICE vehicles to EVs. For example, the system 100 and/or third party compute devices 102 may be embodied as the computing device 200. As shown, the computing device 200 includes at least one processor 202, an I/O subsystem 204, at least one on-die cache 206, and a memory controller 208 to control a volatile memory 210 and a persistent memory 212. The computing device 200 may be embodied as any type of device capable of performing the functions described herein. For example, the computing device 200 may be embodied as, without limitation, a computer, a workstation, a server computer, a laptop computer, a notebook computer, a tablet computer, a smartphone, a mobile computing device, a desktop computer, a distributed computing system, a multiprocessor system, a consumer electronic device, a smart appliance, and/or any other computing device capable of executing software code segments. As shown in FIG. 2, the illustrative computing device 200 includes the processor 202, the I/O subsystem 204, the on-die cache 206, and the memory controller 208 to control volatile memory 210 and persistent memory 212. Of course, the computing device 200 may include other or additional components, such as those commonly found in a workstation (e.g., various input/output devices), in other embodiments. For example, the computing device 200 may include an external storage 214, peripherals 216, and/or a network adapter 218. Additionally, in some embodiments, one or more of the illustrative components may be incorporated in, or otherwise form a portion of, another component. For example, the memory 210, 212 or portions thereof, may be incorporated in the processor 202 in some embodiments.

The processor 202 may be embodied as any type of processor capable of performing the functions described herein. For example, the processor may be embodied as a single or multi-core processor(s), digital signal processor, microcontroller, or other processor or processing/controlling circuit. The volatile memory 210 and persistent memory 212 may be embodied as any type of volatile memory and persistent memory, respectively, capable of performing the functions described herein. Volatile memory 210 contrasts with persistent memory 212 in that the persistent memory 212 does not lose content when power is lost. In operation, the volatile memory 210 and persistent member 212 may store various data and software used during operation of the computing device 200 such as operating systems, applications, programs, libraries, and drivers. The memory 210, 212 is communicatively coupled to the processor 202 via the memory bus using memory control(s) 208, which may be embodied as circuitry and/or components to facilitate input/output operations with the processor 202, the memory 210, 212, and other components of the computing device 200.

The I/O subsystem 204 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processor 202, the memory 210, 212, and other components of the computing device 200, on a single integrated circuit chip.

An external storage device 214 may be coupled to the processor 202 with the I/O subsystem 204. The external storage device 214 may be embodied as any type of device or devices configured for short-term or long-term storage of data such as, for example, memory devices and circuits, memory cards, hard disk drives, solid-state drives, or other data storage devices.

The computing device 200 may also include peripherals 216. The peripherals 216 may include any number of additional input/output devices, interface devices, and/or other peripheral devices. By way of example only, the peripheral 216 may include a display that could be embodied as any type of display capable of displaying digital information such as a liquid crystal display (LCD), a light emitting diode (LED), a plasma display, a cathode ray tube (CRT), or other type of display device.

The computing device 200 illustratively includes a network adapter 218, which may be embodied as any communication circuit, device, or collection thereof, capable of enabling communications between the computing device 200 and other remote devices over a computer network 104. The network adapter 218 may be configured to use any one or more communication technology (e.g., wired or wireless communications) and associated protocols (e.g., Ethernet, Bluetooth®, Wi-Fi®, WiMAX, cellular, etc.) to effect such communication.

FIGS. 3A-3H illustrate examples of various types of input data, output data and process flow for the system 100 according to one embodiment. Although these tables show a variety of parameters regarding data and process, some of these parameters and steps in the process could be optional, depending on the circumstances. As shown in the tables of FIGS. 3A-3H, there is a column 300 that provides an identifier for the process step, a column 302 that provides a description of that process step, a column 304 with an identifier of which step(s) come next in the method to be executed by the system 100, a column 306 identifying which shape type the process step represents (e.g., data, process or decision) in a flow chart, a column 308 representing a function for that process step corresponding to the subsystems 106, 108, 110, 112, 114, 116, 118 of the system 100, a column 310 identifying which phase that step takes place, and a column 312 identifying whether the step is an input or output.

In the embodiment shown, the method executed by the system 100 may include data gathering and/or storage regarding a number of parameters. For example, data regarding vehicle energy analytics (see column 308) may be gathered regarding existing ICE vehicles in the fleet, and possible replacement EVs and stored in the vehicle energy analytics data 120. In the example shown, the type of data that could be gathered for vehicle energy analytics could include deadhead mileage factor (P101), vehicle types (P102), route length (P103), route duration (P104), vehicle efficiency (P105), number of stops (P106), weekly operation schedule (P107), average speed (P108), variable or fixed routes (P109), terrain factor for energy consumption (P110), home roundtrip miles for homebound vehicles (P111), offset hours-average delay in connecting charger (P112), emergency hours of operation for special use vehicles (P113), charging requirements/capabilities (P114), time required to charge (P115), available charging window (P116), charging time of day (P117), frequency of charging (P118), annual operating days (P119), vehicle availability factor (P120), usable V2G capacity per vehicle (P121), CO2 emissions per diesel vehicle per mile (P122), average passenger EV range (P123), average commercial EV range (P124), average battery capacity-passenger EV (P125), and average battery capacity-commercial EV (P126).

As seen in Column 304 (Next Step ID), many of the data parameters for vehicle energy analytics are input to P501 (FIG. 3F), which determines the vehicle energy consumption. Upon determining vehicle energy consumption, that information is output to the next steps of P503 (Project Opex) (FIG. 3F), P504 (V2G Capability) (FIG. 3G), P506 (New Vehicle Requirement) (FIG. 3F), and P519 (Annual Charging Load Growth Per Year) (FIG. 3H) as seen in the “Next Step ID” for P501 under Column 304.

For some parameters of vehicle energy analytics, such as P115 (time required to charge), P116 (available charging window), and P118 (frequency of charging), P123 (average passenger EV range), P124 (average commercial EV range), P125 (average battery capacity-passenger EV), P126 (average battery capacity-commercial EV), this data is input to P517 (new EVs projected per year), as seen under the “Next Step ID” under Column 304. The data for P517 is then input to P518 (% of EVs in new vehicles purchased), which is then input to P501 (vehicle energy consumption, which is discussed above.

For P120 (vehicle availability factor) and P121 (usable V2G capacity per vehicle), this data is input to P504 (V2G capacity) (FIG. 3G). The V2G capacity (P504) is fed as input data to P505 (V2G revenue), which is provided as input to P523 (total cost of ownership model) (FIG. 3H), as shown in the “Next Step ID” under Column 304.

For P122 (CO2 emissions per diesel vehicle per mile), this data is input to P511 (CO2 emissions) (FIG. 3G), and the CO2 emissions data (P511) is fed as input to P524 (low carbon fuel standard (LCFC) credits) (FIG. 3H), which is then input to P523 (total cost of ownership model).

Data regarding EV and Charger Projections (Column 308) are also gathered and stored in EV and Charger Projections 122. In the example shown, the type of data that could be gathered for EV and Charger Projections could include number of vehicles per charger (P201), charger rating (P202), and charger efficiency (P203). In the embodiment shown, each of these types of data P201, P202, and P203 are provided as input to P513 (number and size of chargers) (FIG. 3G). The output of P513 is provided as output to both P330 (charger Capex) (FIG. 3E) and P519 (annual charging load growth per year) (FIG. 3H). With respect to P330 (charger Capex), this is fed as input to P502 (project Capex), which in turn is an input to P516 (cost estimate for site), which is input to P523 (total cost of ownership model). With respect to P519 (annual charging load growth per year), this is input to P520 (grid hosting capacity analysis).

The system may gather cost estimation (Column 308) and stored in cost estimation data 124. In the example shown, the type of data that could be gathered for cost estimate are diesel cost (P301), gas cost (P302), individual diesel vehicle cost (P303), individual electric vehicle cost (P304), and individual charger cost (P305). With regard to diesel cost (P301) and gas cost (P302), these are passed to P337 (fleet Opex) as input, and that is fed to P503 (project Opex) as input data, which is then input data to P523 (total cost of ownership model). With regard to individual diesel vehicle cost (P303) and individual electric vehicle cost (P304), these are fed as input data to P329 (fleet Capex), which in turn is fed as input data to P502 (project Capex). This is then provided as input data to P516 (cost estimate for site), which is input data for P523 (total cost of ownership). Additionally, individual charger cost (P305) is provided as input data to P330 (charger Capex), which is provided as input data to P502 (project Capex). This data is then provided as input to P516 (cost estimate for site), which is provided as input data to P523 (total cost of ownership model).

Data regarding Grants, credits and incentives (Column 308) are also gathered and stored in grants, credits and incentives data 126. In the example shown, the type of data that could be gathered for grants, credits and incentives are V2G charger incentives (P306), non-V2G charger incentives (P307), vehicle incentives (P308), charging infrastructure incentives (P309), and solar incentives (P310). With respect to V2G charger incentives (P306), non-V2G charger incentives (P307), and charging infrastructure incentives (P309), this data is provided as an input to P330 (charger Capex), which is then input data to P502 (Project Capex). This data is then input to P516 (cost estimate for site), which is provided as input to P523 (total cost of ownership model). With regard to P308 (vehicle incentives), this is input data for P329 (fleet Capex), which is fed as input to P502 (project Capex). This data is fed as input to P516 (cost estimate for site), which is then provided as input data for determining P523 (total cost of ownership model). With regard to P310 (solar incentives), this is input data for P335 (solar Capex), which is then input data to P502 (Project Capex). This data is then input to P516 (cost estimate for site), which is provided as input to P523 (total cost of ownership model).

In the example shown, there may be additional cost estimate data stored in the cost estimate data 124. As shown, there is provided charging cost structure (P311), bulk bus purchase discount (P312), battery to bus cost ratio (P313), cost of vehicles (P314), and weighted average cost of capital (P315). With regard to charging cost structure (P311), this is fed as input data to P337 (fleet Opex), which is provided as input data to P503 (project Opex). This data is provided as input to P523 (total cost of ownership model). Other cost estimate data (P312, P313, P314) is provided as input data to P329 (fleet Capex), which is fed as input data to P502 (project Capex). This data is provided as input to P516 (cost estimate for site), which is provided as input to P523 (total cost of ownership model). The remaining cost estimate data (P315) is provided as input data directly to P523 (total cost of ownership model).

Additional data regarding EV and charger projections (Column 308) may also be gathered and stored in EV and charger projections data 122. In the example shown, the type of data that could be gathered for EV and charger projects may be population region (P316), household statistics (P317), car ownership statistics (P318), EV registrations by region (P319), Average commute distance for passenger EV (P320), average commute distance for commercial EV (P321), annual miles driven by type of vehicle (P322), seasonal driving mileage variation (P323), weekly driving mileage variation (P324), vehicle replacement rate-passenger (P325), vehicle replacement rate-commercial (P326), vehicle replacement rate-school bus (P327), and charging preference of users (P328). In this embodiment, each of this data (P316, P317, P318, P319, P320, P321, P322, P323, P324, P325, P326, P327, and P328) is provided as input to P506 (new vehicle requirement) and P517 (new EVs projected per year). With regard to P506 (new vehicle requirement), this is provided as input data to P329 (fleet Capex), which is provided to P502 (project Capex). This data is provided as input to P516 (cost estimate for site), which is provided as input to P523 (total cost of ownership model). With respect to P517 (new EVs projected per year), this is fed as input data to P518 (% of EVs in new vehicles purchased), which is provided as input to P501 (vehicle energy consumption). This data is provided as input to P503 (project Opex), P504 (V2G capacity), P506 (new vehicle requirement), and P519 (annual charging load growth per year). With regard to P519 (annual charging load growth per year), this is input in a determination under P520 (grid hosting capacity analysis). With regard to P506, this flow is described above. P504 (V2G capacity) is provided as input to P505 (V2G revenue), which is fed as input to P523 (total cost of ownership model). With regard to P503 (project Opex), this is fed as input to P523 (total cost of ownership model). With regard to P328, this data is also provided as input to P513 (number and size of chargers), which is provided as input to P330 (charger Capex). This is fed as input to P502 (project Capex), which in turn is an input to P516 (cost estimate for site), which is input to P523 (total cost of ownership model). With regard to P519 (annual charging load growth per year), this is provided as input data to P520 (grid hosting capacity analysis).

Data regarding DER integration and site design (Column 308) may also be gathered and stored in DER integration and site design data 128. In the example shown, the type of data that could be gathered for DER integration and site design may include solar irradiance at site (P332) and feasible area for solar panels (P333). Both of these (P332, P333) are input data to P334 (solar generation estimate), which is fed as input to P507 (solar revenue), which is provided as part of the determination of P523 (total cost of ownership model).

Additional cost estimation may be gathered for maintenance & other costs (P336). This data is provided to P337 (fleet Opex), P338 (solar Opex), and P339 (charger Opex). Each of these is provided as input data to P503 (project Opex), which is fed as input to P523 (total cost of ownership model). Additionally, cost estimate may be gathered for electricity cost (P401). This is provided as input data to P503 (project Opex), which is fed as input to P523 (total cost of ownership model). An additional cost estimate may be gathered for electricity tariff type (P403). This data is provided to P505 (V2G revenue), which is provided as input to P523 (total cost of ownership model).

Additional DER integration and site design (Column 308) may be gathered, such as electric distribution system capacity (P402), solar selling price (P408), and daily and weekly energy peaks at distribution feeder (P409). With regard to electric distribution system capacity (P402) and daily and weekly energy peaks at distribution feeder (P409), these are fed as input to P520 (grid hosting capacity analysis). With regard to solar selling price (P408), this is input to P507 (solar revenue), which is provided as input to P523 (total cost of ownership model).

In some embodiment, the system 100 gathers additional data regarding V2G capacity and revenue estimation (Column 308), which is stored in V2G capacity and revenue estimation data 112. As shown, the system 100 stores data regarding energy arbitrage for V2G (P404), summer/emergency load dispatch incentive (P405), summer/emergency load dispatch events # (P406), and system operator margin (P407). In the embodiment shown, the energy arbitrage for V2G (P404) and system operator margin (P407) are fed as input data to P505 (V2G revenue), which is provided as input to P523 (total cost of ownership model). The summer/emergency load dispatch incentive (P405), summer/emergency load dispatch events # (P406) are provided directly as input data to P523 (total cost of ownership model).

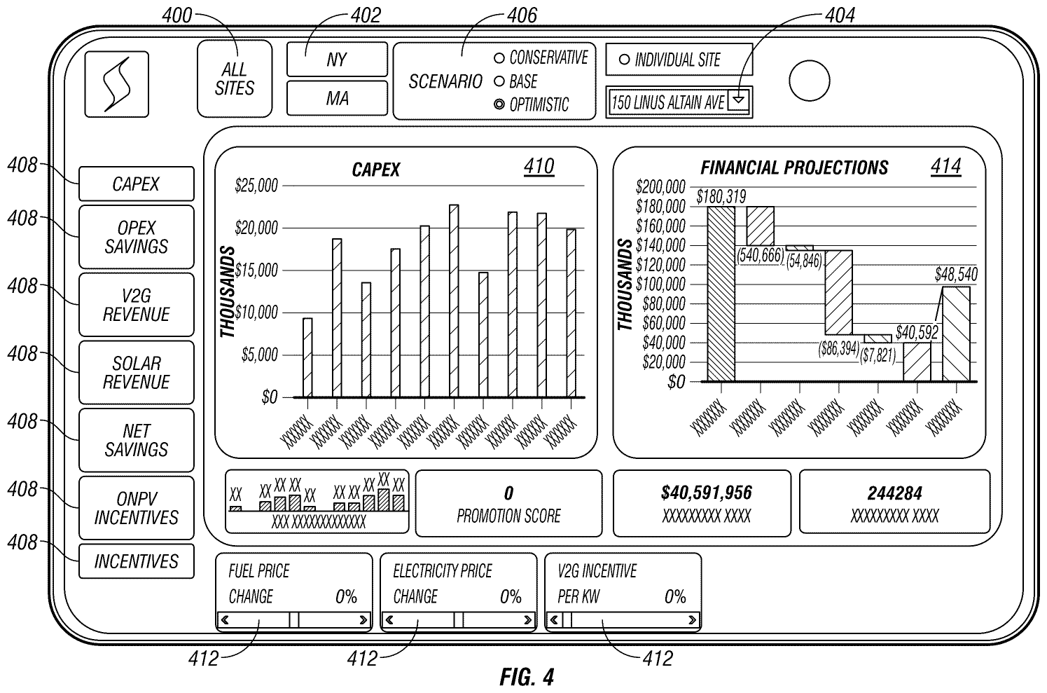

As shown in FIGS. 4-9, some of the determinations made with data shown in FIGS. 3A-3H can be user adjustable through a user interface. In this manner, the user can adjust certain data to determine the impact. The particular data that can be user-adjusted may different depending on the circumstances.

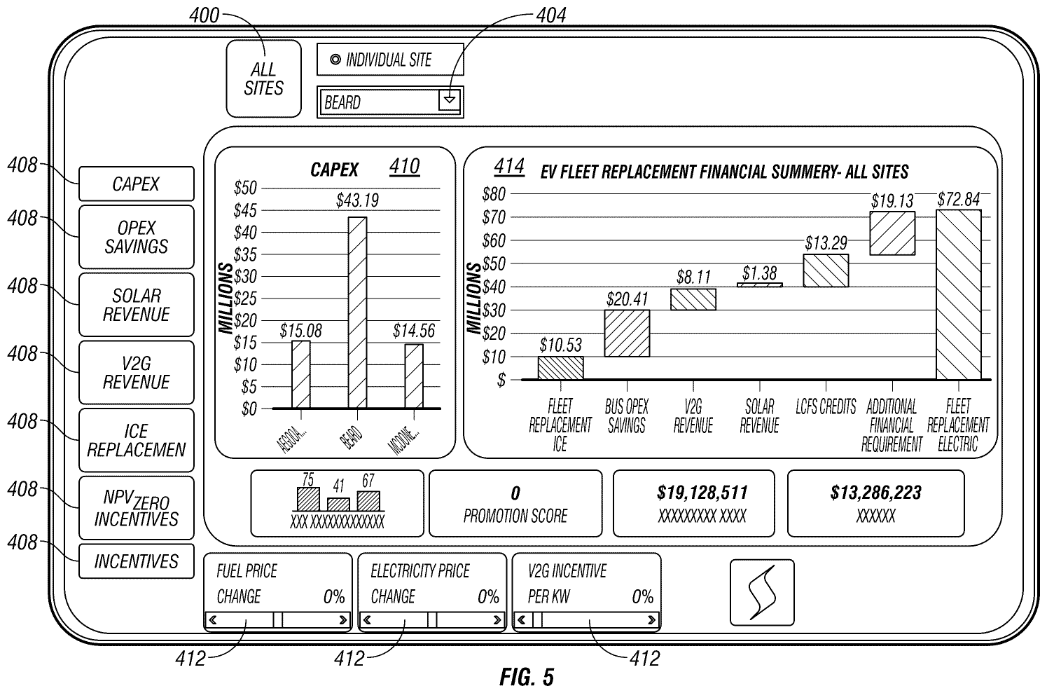

Referring to FIGS. 4 and 5, the user interface includes selectors for determining how many sites for an entity will be determined for the calculation. For example, the user may select a button 400 for “All Sites” to consider all locations as part of the calculation. In some embodiments, there could be buttons 402 for particular states where the entity has locations. In some cases, a specific site or location can be used for the determinations by selecting a specific site, such as through a pull down menu 404. In some cases, the user may select between different energy scenarios, such as with radio buttons 406 for the user to select which scenario will be used in the calculations. As shown, there are a plurality of buttons 408 that can be selected to determine which calculation is shown in graph 410. For example, selecting the CAPEX (i.e., capital expense) button 408, this will cause the projected capital expense on a per location basis to be displayed on graph 410. In the example shown, there are sliders 412 that allow user-adjustment for fuel price, electricity price, and V2G incentive. For example, a user may decrease or increase fuel price using the slider 412 to visually see the impact in the financial projections graph 414 and elsewhere on the interface.

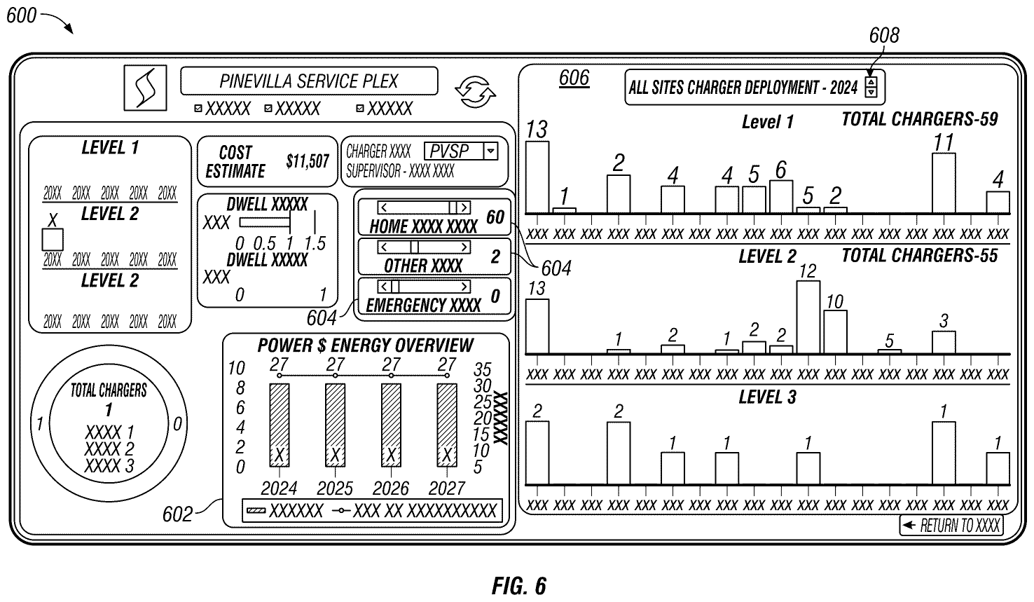

Referring to FIG. 6, there is shown a user interface 600 for making projections regarding different scenarios for transitioning from an ICE vehicle fleet to an EV fleet. In the example user interface shown, there is a power & energy overview graph 602. As shown, there are sliders 604 to adjust home roundtrip miles, offset hours, and emergency hours. Also shown in this embodiment is graphs 606 showing the number of chargers deployed at particular sites in the scenario based on the type of charger (i.e., level 1, 2 or 3). As shown, there are arrows 608 that allow a user to adjust the year, which impacts the number of chargers that are deployed in the graphs 606 based on the forecast.

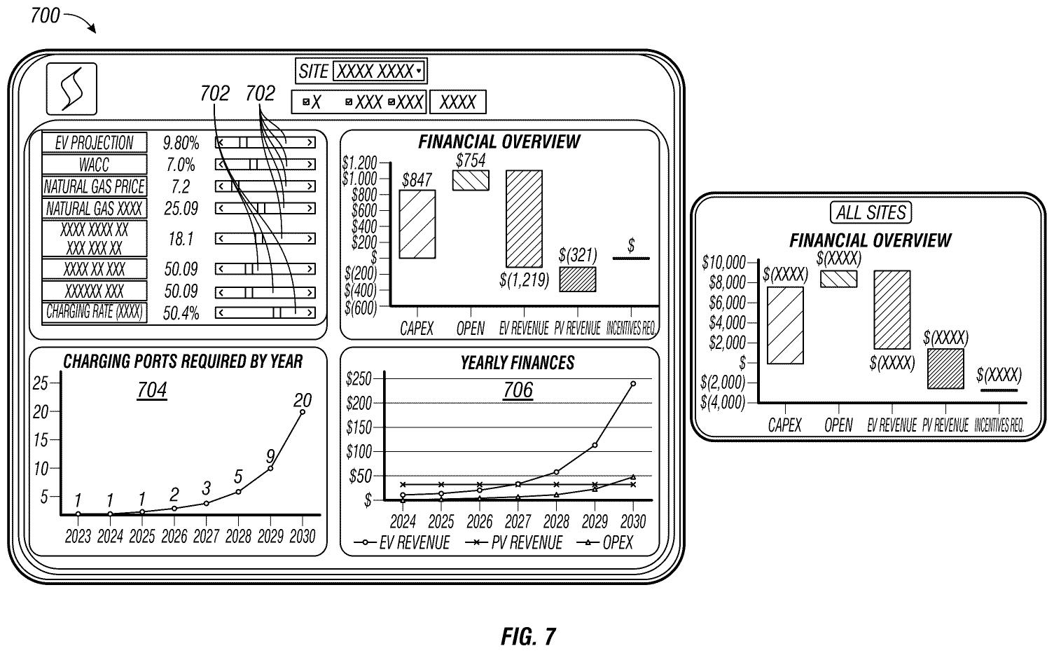

Referring to FIG. 7, there is shown another embodiment of a user interface 700 that could be used with the system 100. In this embodiment, there are a plurality of sliders 702 can be used to adjust a variety of input data, such as EV projection, WACC, natural gas price, natural gas/kWh, building usage of natural gas per square foot, cost of electricity, solar selling price, and charging rate. By adjusting these parameters, the user can visualize the impact of the adjustments on charging ports required per year 704 and yearly finances 706, among other things.

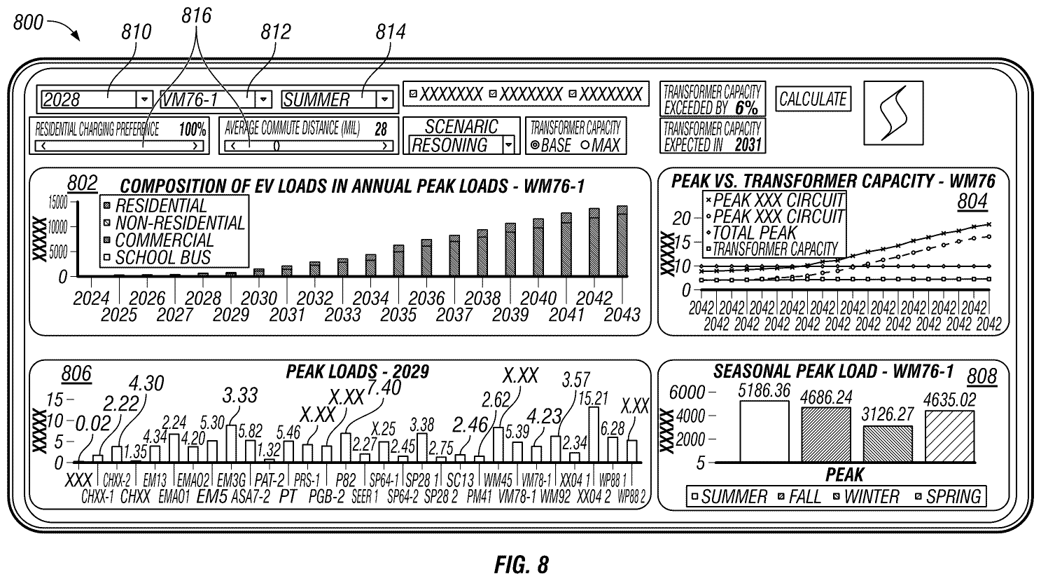

Referring to FIG. 8, another embodiment of the user interface 800 for the system 100 is shown. In this example, this user interface could be used by a utility to make forecasts regarding the electrical grid based on an impact of EVs using the grid. As shown, this user interface includes a graph for composition of EV loads 802, a graph of peak vs. transformer capacity 804, a graph for peak loads for a particular year 806, and a seasonal peak load graph 808. In the embodiment shown, there are pull down menus for projected year 810, a site selector 812, a season selector 814. This example user interface 800 includes sliders 816 for residential charging preference and average commute distance.

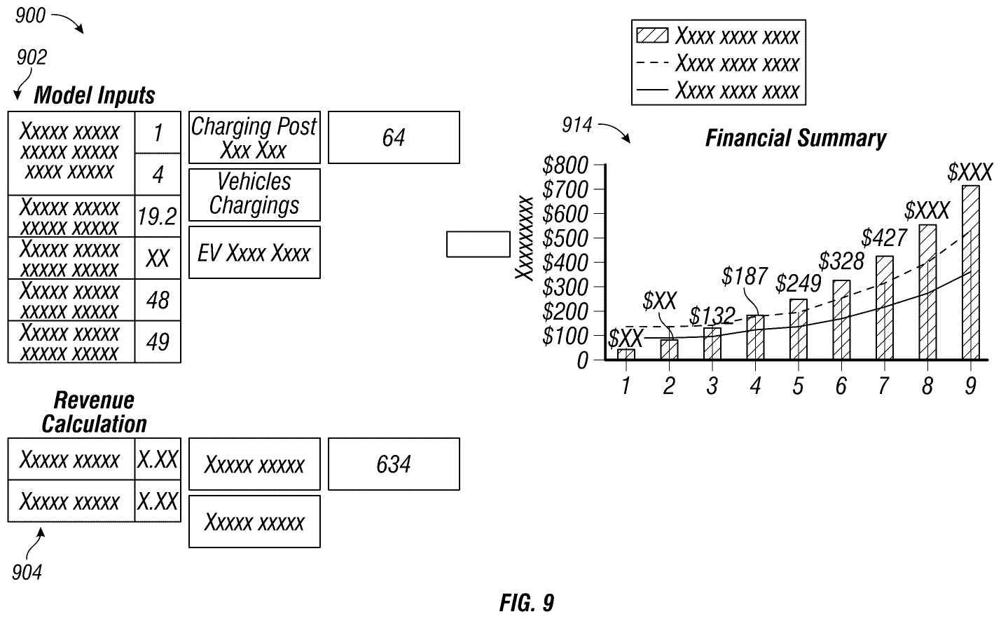

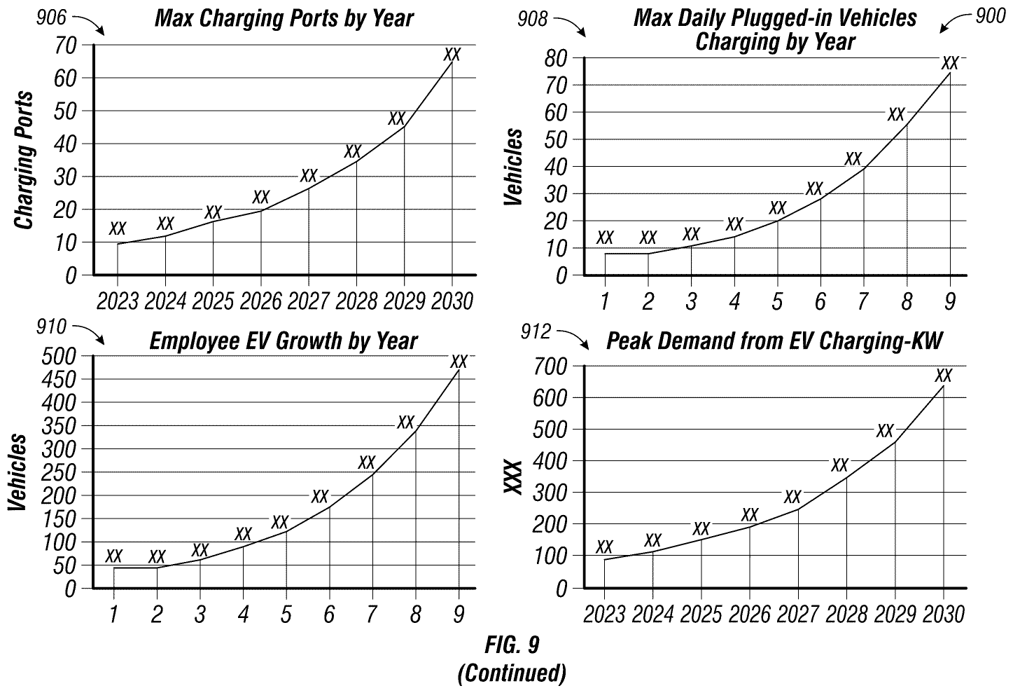

Referring to FIG. 9, there is shown another example user interface 900 that could be used with the system 100. In the example shown, there are model inputs 902 that can be adjusted. There are also parameters for revenue calculation 904 can be adjusted. As shown, there are graphs for max charging ports per year 906, max daily plugged-in vehicles charging per year 908, employee EV growth per year, and peak demand from EV charging 910. There is also a graph to present a financial summary 914 for the selected parameters.

1. A computer-implemented method for performing forecasts for entities planning to transition from a vehicle fleet with internal combustion engines (“ICE”) to an electric vehicle (“EV”) fleet, the method comprising:
storing vehicle energy analytics on an existing fleet of ICE vehicles and a replacement fleet of electronic vehicles (EVs);
storing financial analytics regarding potential grants, credits and/or incentives for the replacement fleet of EVs;
determining a total cost of ownership regarding the replacement fleet of EVs based on the vehicle energy analytics and/or the financial analytics regarding potential grants, credits and/or incentives for the replacement fleet of EVs; and
displaying on a user interface a forecast regarding the total cost of ownership, wherein the user interface includes user-adjustable elements to change one or more parameters regarding the vehicle energy analytics and the financial analytics, wherein the user interface is configured to adjust total cost of ownership in real-time based on adjustment to the user-adjustable elements.

2. The computer-implemented method of claim 1, wherein determining the total cost of ownership includes evaluating route information from a feasibility study regarding one or more of the existing vehicle fleet and/or the replacement fleet.

3. The computer-implemented method of claim 1, wherein determining the total cost of ownership includes evaluating the real-world driving dynamics of the replacement fleet.

4. The computer-implemented method of claim 3, wherein evaluating the real-world driving dynamics comprises one or more of capacity loss, seasonal variations, and/or impact of average speed of driver (converted into energy consumption).

5. The computer-implemented method of claim 1, wherein determining the total cost of ownership includes deriving vehicle-to-grid revenue estimation from existing energy storage and solar tariff structures.

6. The computer-implemented method of claim 1, wherein determining the total cost of ownership includes incorporating battery degradation into energy consumption predictions impacting costs.

7. The computer-implemented method of claim 1, further comprising generating a long term strategy and roadmap for an electrification project for an entire fleet.

8. The computer-implemented method of claim 7, wherein generating the long term strategy and roadmap includes a determination of one or more of vehicle transition, charging infrastructure needs, available incentives, utility constraints, incorporation of costs and revenue from V2G opportunities.

9. The computer-implemented method of claim 1, further comprising generating EV projection estimates for residential, workplace, and/or commercial charging use cases for the replacement fleet.

10. The computer-implemented method of claim 9, wherein EV projection estimates include projections using one or more of reference databases such as the National Household Travel Survey, Department of Transportation Annual Statistics, seasonal factors, and/or proximity to distribution feeders and distribution feeder capacity to estimate EV use growth in certain areas.

11. The computer-implemented method of claim 9, further comprising determining location identification and placement of EV infrastructure for the replacement fleet.

12. A system for performing forecasts for entities planning to transition from a vehicle fleet with internal combustion engines (“ICE”) to an electric vehicle (“EV”) fleet, the system comprising:
circuitry configured to:
store vehicle energy analytics on an existing fleet of ICE vehicles and a replacement fleet of electronic vehicles (EVs);
store financial analytics regarding potential grants, credits and/or incentives for the replacement fleet of EVs;
determine a total cost of ownership regarding the replacement fleet of EVs based on the vehicle energy analytics and/or the financial analytics regarding potential grants, credits and/or incentives for the replacement fleet of EVs; and
display on a user interface a forecast regarding the total cost of ownership, wherein the user interface includes user-adjustable elements to change one or more parameters regarding the vehicle energy analytics and the financial analytics, wherein the user interface is configured to adjust total cost of ownership in real-time based on adjustment to the user-adjustable elements.

13. The system of claim 12, wherein to determine the total cost of ownership includes evaluating route information from a feasibility study regarding one or more of the existing vehicle fleet and/or the replacement fleet.

14. The system of claim 12, wherein to determine the total cost of ownership includes evaluating the real-world driving dynamics of the replacement fleet.

15. The system of claim 14, wherein to evaluate the real-world driving dynamics comprises one or more of capacity loss, seasonal variations, and/or impact of average speed of driver (converted into energy consumption).

16. The system of claim 12, wherein to determine the total cost of ownership includes deriving vehicle-to-grid revenue estimation from existing energy storage and solar tariff structures.

17. The system of claim 12, wherein to determine the total cost of ownership includes incorporating battery degradation into energy consumption predictions impacting costs.

18. The system of claim 12, further comprising circuitry configured to generate a long term strategy and roadmap for an electrification project for an entire fleet.

19. The system of claim 18, wherein to generate the long term strategy and roadmap includes a determination of one or more of vehicle transition, charging infrastructure needs, available incentives, utility constraints, incorporation of costs and revenue from V2G opportunities.

20. The system of claim 12, further comprising circuitry configured to generate EV projection estimates for residential, workplace, and/or commercial charging use cases for the replacement fleet.

21. The system of claim 20, wherein EV projection estimates include projections using one or more of reference databases such as the National Household Travel Survey, Department of Transportation Annual Statistics, seasonal factors, and/or proximity to distribution feeders and distribution feeder capacity to estimate EV use growth in certain areas.

22. The system of claim 20, further comprising circuitry to determine location identification and placement of EV infrastructure for the replacement fleet.
